(19) United States
(12) Patent Application Publication
(10) Pub. No.: US 2006/0180792 A1
(43) Pub. Date: Aug. 17, 2006

(54) Security marker having overt and covert security features

(75) Inventors: Christopher P. Ricci, Dayton, OH (US); Gary A. Ross, Edinburgh (GB)

Correspondence Address: Christopher P. Ricci;NCR Corporation, Intellectual Property Section, Law Department, 1700 South Patterson Blvd., Dayton, OH, 45479-0001, US

(73) Assignee: Prime Technology LLC

(21) Appl. No.: 11/388,368

(22) Filed: Mar. 24, 2006

Related U.S. Application Data
(63) Continuation-in-part of application No. 11/265,648, filed on Nov. 2, 2005.
Application No. 11/265,648 is a continuation-in-part of application No. 11/016,658, filed on Dec. 17, 2004.
Application No. 11/016,658 is a continuation-in-part of application No. 10/822,582, filed on Apr. 12, 2004.

(30) Foreign Application Priority Data
Jun. 26, 2003 (GB) 0314883.0

(51) Int. Cl. C09K 11/02; B05B 5/00

(52) U.S. Cl. 252/301.16; 252/301.35; 252/301.36; 252/301.4 F; 106/31.64; 252/301.4 R; 427/157

(57) ABSTRACT

A security marker for use as an anti-counterfeiting or security measure is described. The marker comprising at least one security tag comprising a first dopant incorporated into a host and a second dopant incorporated into a host. The first dopant interacts with its host to luminesce in the visible region of the electromagnetic spectrum upon excitation at a first wavelength, and the second dopant interacts with its host only upon excitation at a second wavelength.

### CROSS-REFERENCE TO RELATED APPLICATIONS

This application is a continuation-in-part of U.S. application Ser. No. 11/265,648, filed Nov. 2, 2005, now pending; which is a continuation-in-part of U.S. application Ser. No. 11/016,658, filed Dec. 17, 2004, now pending; which is a continuation-in-part of U.S. application Ser. No. 10/822,582, filed Apr. 12, 2004, now pending; which claims the benefit of Great Britain Application No. 0314833.0, filed Jun. 26, 2003.

### TECHNICAL FIELD

The subject matter described herein relates to a security marker containing at least one security tag. The security marker produces at least two distinctive emission profiles, where one of the emission profiles is in the visible light range.

### BACKGROUND

Counterfeiting of goods and documents is a global problem and a variety of security features have been developed as preventive measures. For example, banknotes typically include security markers such as watermarks, fluorescent inks, security threads, or holograms. Such security markers serve an anti-counterfeiting function, in addition to providing a method for validation or authentication of the document. By way of another example, various consumer goods might contain a magnetic tag affixed to or inserted in the merchandise. The magnetic, typically iron-containing, tag can be activated and deactivated. When in the activated state, its presence can be detected in a low frequency magnetic field.

Traditionally, security “taggants”, also referred as labels or tags, are visible to the human eye or become visible under selected conditions. For example, a hologram, security thread, or watermark, can be typically visualized upon inspection with the eye. Fluorescent inks, on the other hand, are rendered visible upon exposure to ultraviolet light. Alternatively, the security tag can simply be hidden from view of the consumer. For example, a magnetic tag can be affixed inside a spine of a book and not readily visible.

There remains a need in the art for more sophisticated security markers, particularly for documents, such as currency, checks, tickets, credit cards, and identification papers, for high value consumer goods, and for items related to individual and national security, such as weapons, explosives, and the like.

### SUMMARY

In one aspect the invention includes a security marker, comprising at least one security tag comprised of a first dopant incorporated into a host and a second dopant incorporated into a host. The first dopant interacts with its host to luminesce in the visible region of the electromagnetic spectrum upon excitation at a first wavelength, and the second dopant interacts with its host upon excitation at a second wavelength.

In one embodiment, the second dopant interacts with its host to luminesce in the visible region of the electromagnetic spectrum upon excitation at the second wavelength. In another embodiment, the second dopant interacts with its host to luminesce outside of the visible region of the electromagnetic spectrum upon excitation at the second wavelength.

In another embodiment, the first dopant interacts with its host to luminesce upon excitation at a first wavelength that is in the visible region of the electromagnetic spectrum.

In another embodiment, the second dopant interacts with its host to luminesce upon excitation at a second wavelength that is in the ultraviolet or infrared region of the electromagnetic spectrum.

The first dopant, in another embodiment, interacts with its host to luminesce at a first luminescent frequency, and the second wavelength suitable for excitation of the second dopant is different from the first luminescent frequency.

At least one of the first or second dopant may be a rare earth ion, such as a lanthanide. In one embodiment the first dopant is europium and the second dopant is terbium.

In one general embodiment, the first dopant and second dopant are incorporated into a single host, such as a glass or polymer. One exemplary glass comprises a borosilicate glass.

In a second general embodiment, the security marker comprises two or more security tags, one tag composed of the first dopant incorporated into a first host and a second tag composed of the second dopant incorporated into a second host. The first and/or second host may be glass or a polymer. One exemplary glass comprises a borosilicate glass.

The security marker may be applied to or incorporated into an object to be identified or validated, wherein the marker must be viewed at both the first and second wavelengths for the object to be identified or validated.

Also disclosed is an anti-counterfeiting method for use in identifying or validating an object. The method includes providing the object with a security marker of the type described above, such that the marker must be viewed at both the first and second wavelengths for the marker to be identified or validated.

In addition to the exemplary aspects and embodiments described above, further aspects and embodiments will become apparent by reference to the drawings and by study of the following descriptions, which are given by way of example.

### BRIEF DESCRIPTION OF THE DRAWINGS

FIGS. 1A-1C shows various exemplary embodiments of items bearing a security marker comprised of at least one security tag.

### DETAILED DESCRIPTION

### I. Definitions

The term “lanthanide” refers to the 15 elements in the periodic table of the elements corresponding to atomic numbers 57 to 71. The lanthanides are generally considered to include lanthanum, cerium, praseodymium, neodymium, promethium, samarium, europium, gadolinium, terbium, dysprosium, holmium, erbium, thulium, ytterbium, and lutetium.

The actinide series intends the radioactive elements in the periodic table with atomic numbers ranging from 89 to 103. The actinides typically include actinium, thorium, protactinium, uranium, neptunium, plutonium, americium, curium, berkelium, californium, einsteinium, fermium, mendelevium, nobelium, and lawrencium.

A “rare earth element” refers one of the 17 elements of the periodic table corresponding to scandium, yttrium, and the lanthanides. The term intends the neat element, the element in modified form, such as in the form of an ion, oxide, chelate, or a composition containing a rare earth element.

“Dopant” intends a compound, such as a rare-earth element, that can luminesce upon exposure to an excitation source of a particular wavelength.

“Visible light range” intends the region of the electromagnetic spectrum that is typically visible to the unaided human eye. This range is generally considered to include wavelengths from approximately 380 nm to approximately 740 nm.

The term “outside the visible region” refers to the portion of the electromagnetic spectrum other than the visible light range. In a preferred embodiment, the term outside the visible region refers to the infrared and ultraviolet regions of the electromagnetic spectrum.

The “excitation wavelength” is the radiation wavelength used to excite an electron.

By “laminate” intends a good that is comprised of a series of thin layers (laminae), each thin layer being of the same or different material.

### II. Security Marker

In one embodiment, a security marker comprised of at least one security tag is provided. As will be illustrated by the description below, the security marker has both an overt security feature and a covert security feature, by virtue of first and second dopants, in the one or more security tags, that luminesce upon excitation. The first dopant luminesces, preferably in the visible region of the electromagnetic spectrum, upon exposure to a first excitation wavelength. The second dopant luminesces upon excitation with a second excitation wavelength. The first dopant corresponds to an overt security feature, as luminescence in the visible region is readily observed. The second dopant corresponds to a covert security feature, and in one embodiment requires excitation and/or detection using an instrument. For example, excitation of the second dopant may rely on an instrument that produces a radiation having a wavelength outside the visible region of the electromagnetic spectrum. Alternatively or additionally, detection of luminescence produced by the second dopant may rely on a detector other than the human eye. This section describes security tags used to form the security marker, various items bearing a security marker, and detection of the security marker.

A. Security Tags and Items Comprising Security Tags

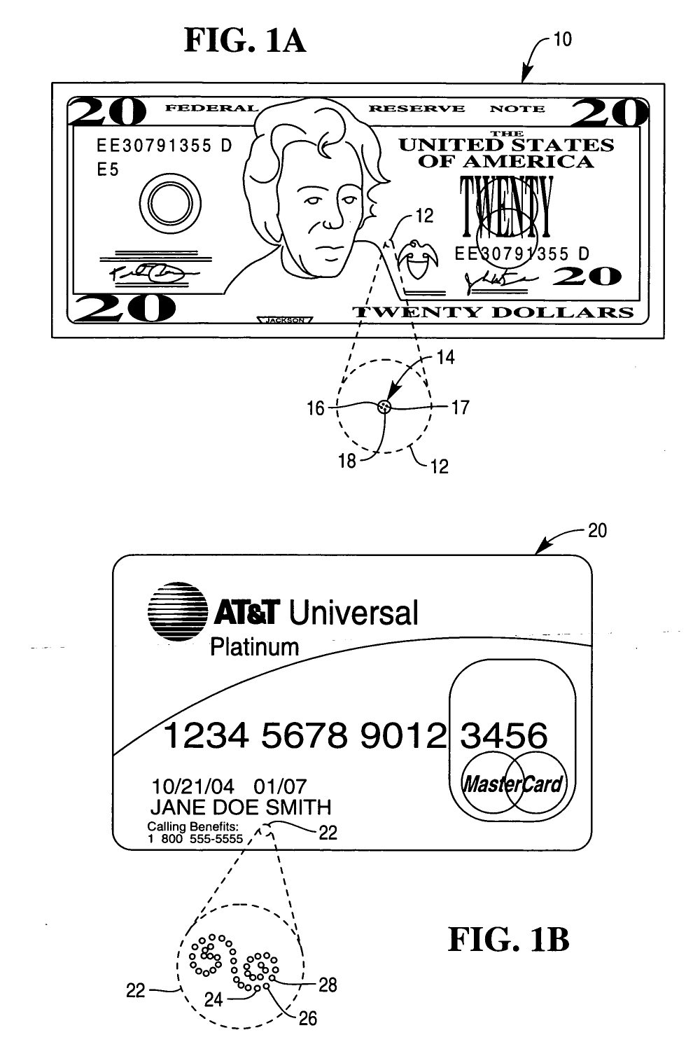

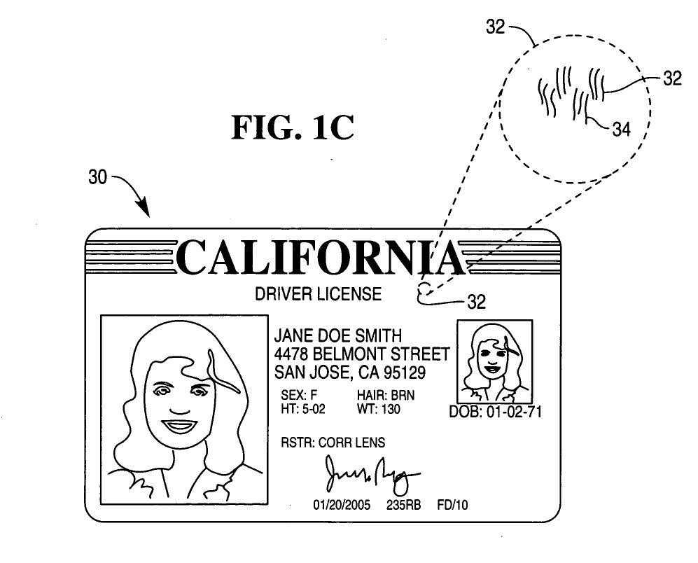

FIG. 1A illustrates one embodiment of the security marker. A document such as a bank note 10 includes a security marker 12, which is also illustrated in exploded view in the figure. The security marker is comprised of a security tag 14 that includes a first dopant 16 and a second dopant 17. The first dopant and the second dopant are incorporated into a host 18. In this embodiment, the security tag is physically shaped as a bead having a size in the range of between about 0.1-100 micrometer. Formation of microbead security tags comprised of a dopant incorporated into a host comprised of a glass is described in Example 1.

The first dopant in security marker 12 luminesces in the visible light region of the electromagnetic spectrum when exposed to an excitation source at a first wavelength. The first excitation wavelength can be in the visible region or outside of the visible region of the electromagnetic spectrum. The second dopant luminesces when exposed to a second excitation wavelength, where the second wavelength can be in the visible region or outside the visible light region of the electromagnetic spectrum. The luminescence of the second dopant can be in the visible region or outside the visible light region of the electromagnetic spectrum.

In a preferred embodiment, the first dopant interacts with the host to emit a spectral signature that is distinct from the spectral signature of the dopant alone and that is distinct from the spectral signature of the host alone, when excited with the same excitation wavelength. Similarly, the second dopant interacts with the host to produce a distinctive spectral signature. In another preferred embodiment, the luminescence produced by the first dopant upon excitation at a first wavelength does not excite the second dopant; that is, the frequency of the luminescence emitted from the first dopant does not excite the second dopant to luminesce.

FIG. 1B illustrates another embodiment of the security marker. Document 20, shown here as a credit card, includes a security marker 22, also shown in exploded view. The security marker is comprised of a collection of security tags, exemplified as those identified by 24, 26, 28. Each tag in the collection has the same composition, where each tag includes a first dopant and a second dopant both incorporated into a host, as described with respect to FIG. 1A. It will be appreciated that the first dopant and the second dopant can be incorporated together into a single host, or incorporated into individual hosts of the same or a different host material. The dopants and host are formed into particles in the nanometer size range of between about 0.1 nm to 100 nm. The two dopants interact with their host to produce two detectable spectral emissions when excited at appropriate wavelengths. More specifically, the first dopant is capable of luminescence in the visible region of the electromagnetic spectrum upon excitation at a first wavelength, which can be in any region of the electromagnetic spectrum. The second dopant luminesces upon excitation at a second wavelength.

In one embodiment, the first dopant luminesces in the visible spectrum when excited. The second dopant is excited outside the visible region of the spectrum, hence is not excited by the luminescence of the first dopant, and therefore remains undetected and undetectable until appropriately excited.

FIG. 1C illustrates yet another embodiment of the security marker. In this embodiment, a document 30, such as an identification card, includes a security marker 32 that is comprised of two or more security tags, such as tags 33, 34. Security tags 33, 34 have different compositions and each tag will luminesce upon excitation at a distinct wavelength; that is excitation of security tag 33 occurs at a wavelength different from the excitation wavelength needed to excite security tag 34.

In the embodiments illustrated in FIGS. 1A-1C, one of the security tags luminesces in the visible region of the electromagnetic spectrum when excited at a first wavelength. The other security tag luminesces upon excitation at a second wavelength different from the first wavelength. In a preferred embodiment, the first wavelength and the second wavelengths are in the visible region of the electromagnetic spectrum. In another embodiment, the first wavelength is in the visible region, and the second wavelength is outside the visible region, preferably in the infrared or ultraviolet region. The luminescence of the security tag that is excited by the first wavelength does not excite the security tag that is responsive to the second wavelength. In this way, two distinct spectral signatures are evoked by excitation at two distinct excitation frequencies, providing enhanced security to an item.

It will be appreciated that the arrangement of the security tags within the marker is unlimited. The tags can be randomly arranged or arranged in a distinctive pattern that provides a secondary level of security. The shape of the security tags is also unlimited, with spherical particles, irregularly shaped particles, and fibrous strands being exemplary. The shape, location, and pattern of the security tags are selected based on, at least in part, the item into which the tags are to be placed and the host. It will also be appreciated that any combination of tag shapes, types, patterns, compositions, etc. can be selected for formation of a security marker.

1. Security Tag Components

Each security tag is comprised of at least one dopant incorporated into a host. In some embodiment, two, or more, dopants are incorporated into a single host. Materials suitable for the dopant and for the host are described in U.S. Publication No. U.S. 2004-0262657, incorporated by reference herein. These materials are described briefly below.

i. Dopant

In one embodiment, the dopant is selected from an element in group 3 of the Periodic Table. Specifically, the group 3 elements include scandium, yttrium, the lanthanide series, and the actinide series. In a more preferred embodiment, the dopant is a rare earth element. Rare earth elements have specific spectral properties making them particularly well suited for use as a dopant. The trivalent configuration of rare earth ions partly shields the optically active electrons permitting characteristic line type emissions from these ions.

The lanthanide series of elements are preferred dopants, particularly a lanthanide selected from atomic numbers 58 to 71. By way of example, a security tag can be formed from europium incorporated into a host. A security tag formed from terbium incorporated into a host is another example. In the embodiments where two dopants are incorporated into a single host the first dopant can be europium and the second dopant can be terbium.

Some of the rare earth elements have little luminescence in the pure state. However, when some of the rare earth atoms in a pure crystalline rare earth element are replaced by an impurity such as another rare earth element, a high degree of luminescence may be achieved. The dopant may therefore include activated or impure crystalline powders, e.g. terbium-activated gadolinium oxysulphide (Gd₂O₂S:Tb) and thulium-activated lanthanum oxybromide (LaOBr:Tm). The rare earth dopant can also be present as a chelate. It may further be desirable to add secondary dopants, such as other rare earth elements, to a primary dopant selected for use in a security tag to produce luminescence at a pre-selected wavelength. The secondary dopant acts to strengthen the luminescent intensity at the pre-selected wavelength.

ii. Host

The dopant is incorporated into a host for formation of a security tag. As noted above, in some cases two or more dopants are incorporated into a host. The dopant(s) interacts with the host to produce a distinctive spectral emission(s), as further described below.

The host is typically formed from a glass or a polymeric material, and preparation of an exemplary host comprising borosilicate glass is set forth in Example 1. Preferred glasses have a soft point of about 740° C., although the exact melting point depends on the specific glass used, and may vary from about 700° C. to about 1500° C. Polymers suitable for formation of the host include those with a high melting transition and that are rigid are room temperature. Engineering plastics, include, but are not limited to, polysulfones, polyamides, polyethylene terephthalate, polycarbonate, polystyrene, polyurethanes, polypropylene, polyvinylchloride, polyester, polyethylene, copolymers, and blends, and mixtures of various engineering plastics, such as acrylonitrile-butadiene-styrene.

B. Security Tag Detection

The interaction of the host and the dopant(s) is such that the spectral response of the dopant is different from that of the dopant or the host alone. In particular, the interaction between the host and the dopant is such that the intrinsic energy levels of the dopant change when it is incorporated into the host. For example, when the dopant is incorporated into a glass, new bonds are formed in the doped glass, thus altering the electron arrangement and hence the energy levels of absorption and emission. Altering the dopant and/or dopant chelate and/or the host material changes these energy levels and hence the luminescent fingerprint of the components. It will further be appreciated that selection of host material may alter emission persistence. Certain hosts may quench or extend the emission. This emission persistence may further be used as a security feature.

By virtue of the unique spectral signature of the tags, a security marker is formed that is tailored to have a specific spectral signature upon excitation at two distinct radiation wavelengths. Exposure of a document containing the security marker to a first excitation source that produces a radiation wavelength in the visible region excites the security tag designed for response to this wavelength. Inspection of the document upon excitation permits visualization of these overt security tags. For further authentication or validation of the document, exposure to a second light source having a wavelength different from the first excitation source excites the security tags responsive to the second wavelength. Inspection of the document for the presence or absence of these covert security tags allows authentication or validation of the document.

As noted above, the host may take any appropriate form such as a bead, a filament, a spray, a coating, a film, and/or an adhesive. Alternatively, the dopant or security tag may be an integral part of the item to be authenticated. For example, the security tag may be incorporated in the material forming the item to be authenticated, such as in a polymer matrix or paper laminate. The security tags may be included in a medium for application to the item to be secured against counterfeiting, for example, the tags may be incorporated into a fluid such as an ink.

One type of security tag includes europium as the overt dopant and terbium as the covert dopant, where both dopants are incorporated into a single host, which may be borosilicate glass. In one example, this security tag is in the form of a microbead or a nanobead.

Several methods for doping standard glass compositions with a selected dopant(s) can be employed. In one method, doped glass is prepared by mixing powdered glass and a dopant(s) to above the melting point of the mixture. In another method, a glass is powdered and mixed with solutions of the dopant. The glass is lifted out of the solvent, washed and then oven dried. In another method, oxides and dopants are mixed in a solution of glass or polymer. The mixture is baked and then pulverized or milled to an appropriate size.

It will be appreciated that various ratios and concentrations of dopants in the host may be used. Typically between about 0.5-5 mole percent of dopant (based upon the total number of moles of oxides and dopants) is used in a host to form a tag. The dopant can be a single dopant or a mixture of two or more dopants. For example a single host might contain 1 mole percent Eu and 1 mole percent Tb. By way of another example, a host might contain 3 mole percent Dy.

Table 1 shows the emission wavelength and fluorescent intensity for various different excitation wavelengths for a security tag comprised of three mole percent EuCl₃ incorporated into a borosilicate based glass, prepared as described in Example 1.

TABLE 1
Properties of Security Tags Prepared from
Europium in borosilicate-based glass

| Excitation Wavelength | Emission Wavelength | |
|---|---|---|
| (nm) | (nm) | Fluorescent Intensity |
| 395 | 535 | 14 |
| 395 | 590.5 | 83 |
| 395 | 615 | 285 |
| 395 | 654 | 13 |
| 415 | 590 | 11 |
| 415 | 615 | 31 |
| 465 | 615 | 176 |
| 465 | 591 | 38 |
| 535 | 615 | 28 |

By way of comparison, Table 2 shows emission wavelength and fluorescent intensity for EuCl₃:6H₂O in an aqueous solution.

TABLE 2
Properties of Europium in Aqueous Solution

| Excitation Wavelength | Emission Wavelength | |
|---|---|---|
| (nm) | (nm) | Fluorescent Intensity |
| 395 | 526 | 14 |
| 395 | 536 | 83 |
| 395 | 556 | 285 |
| 395 | 592 | 13 |
| 395 | 618 | 11 |
| 415 | — | 31 |
| 465 | 594 | 176 |
| 465 | 616.5 | 38 |
| 465 | 700 | 3.9 |
| 535 | 592 | 1.1 |

As seen from Tables 1 and 2, europium incorporated into a glass host emits at 615 nm and 590.5 nm when excited at 395 nm. The corresponding results for the EuCl₃:6H₂O in solution shows that the strongest emission wavelengths are 592.5 nm, 618.5 nm, 556.5 nm, 536 nm and 526 nm. Hence the spectral response of the dopant in glass is significantly different from that of the EUCl₃:6H₂O in solution. Also, when the dopant in glass was excited at a wavelength of 415 nm, there was an output of 615 nm and 590.5 nm. In contrast, for the EuCl₃:6H₂O in solution there was effectively no fluorescence at this wavelength. Again, this demonstrates that there are significant and measurable differences caused by the incorporation of the EuCl₃:6H₂O in the borosilicate host.

### III. Methods of Use

There are innumerable items and objects that are subject to counterfeiting or forgery and that would benefit from a security marker as described herein. For example, financial documents, such as banknotes, traveler's checks, checks, currency, credit cards, bank cards, stock certificates, and bearer bonds, identification credentials, such as identification cards, passports, visas, licenses, and immigration documents, tickets, and certificates are suitable for use with the security markers described herein. Additionally, a wide variety of products and manufactured goods may benefit from the security markers including, but not limited to, computer parts, software packaging, and pharmaceutical packaging.

The security tags can be affixed to or incorporated into or onto an item by various methodologies. For example, the security tags can be incorporated into an ink or a paint that is applied to the item, resulting in formation of a security marker on the item. Alternatively, the security tags can be incorporated into one or more layers of a laminate, for fabrication of a security marker. It will also be appreciated that the at least one security tag can be incorporated into the material from which the item is made, such as a plastic melt during injection molding of a credit card or a gift card. Many other methods for incorporating or affixing a security marker comprised of at least one security tag can be discerned by a skilled artisan.

In another aspect, a method for reducing the risk of counterfeiting and/or for determining whether an item is genuine is provided. In the method, a security marker is provided on the item. The security marker is comprised of at least one security tag comprising a first dopant and a second dopant, as described above. Authenticity of the item is determined by exposing the item to a first excitation wavelength, which can be in the visible region of the electromagnetic spectrum or outside the visible region. The overt security tag(s) will luminesce, preferably in the visible region, and detection of this luminescence permits verification of the presence of the overt security tag(s). The item is also exposed to a second excitation wavelength that is different from the first excitation wavelength, to effect luminescence of the covert security tag(s) that are responsive to this second excitation wavelength. Detection of the covert security tags provides additional verification of the item's authenticity.

In one embodiment, the item is first excited with an emitter, for example a light emitting diode (LED), the output of which may be provided with a narrow band filter. The narrow band filter allows only a very narrow, pre-determined range of wavelengths to be passed for illumination of the security marker. As an example, the filter could be selected to allow a narrow band pass centered on a selected wavelength. For example, for a security tag comprised of europium in borosilicate based glass, an excitation wavelength of 395 or 465 nm could be used. The fluorescent emission can either be visually detected or can be detected using a detector, such as a photodiode. The detector may include a narrow band filter that allows only a very narrow, pre-determined range of wavelengths to pass through it. As an example, the filter could be selected to allow light centered on a wavelength of 615 nm to reach the detector. In use of this arrangement, light is emitted from the emitter and passed through the first narrow band filter and onto a security item that carries or includes the marker. This light is absorbed by the dopant, which if it matches the energy levels of the dopant and host used causes it to luminesce. Light emitted from the item is transmitted towards the second filter, and from there, to the detector. This process is then repeated at a second wavelength, for inspection for the presence or absence of the covert security feature. In this manner, the security marker is illuminated with one or more wavelengths for producing the distinctive spectral signature of the security marker. In the event that the detected response has the expected spectral features, the item is identified as bona fide. In the event that the response is not as expected or is not within an acceptable range of the expected response, the item is identified as being counterfeit or fraudulently obtained or prepared. Thus, emission of the overt and covert security tag(s) at particular wavelengths may be used for validation or authentication of the item bearing the security marker.

In one embodiment, the covert feature is in the form of a spatial code. For example, a spatial code can be a typical UPC or RSS bar code, or any other kind of code. In another embodiment, the covert security tag(s) occupy the white space in a spatial code comprised of overt security tags forming the bar(s) in the spatial code. For example, a bar code can be printed wherein the ink for printing the bars is comprised of overt security tags and the white space between the bars is printed with a clear ink containing covert security tags. This allows a person desiring to validate an item carrying the bar code to locate the covert security feature on the item, while disguising the covert security feature by printing a conventional bar code in the vicinity of (for example, on top of, or partly overlapping) the covert security feature.

It will be appreciated that the luminescent intensity of the overt and covert security features may also be used for validation of the item bearing the security marker. Also the emission from each security tag may decay over a different time period. By virtue of this feature, the time over which an emission occurs for a particular wavelength can be used as part of a security profile. These features may be used singly or in combination for validation of the item.

It will be appreciated that the covert and overt features can be detected simultaneously or sequentially. For example, the overt security feature may be used by a cashier or clerk or other person using a simple illumination device to verify authenticity of an item. In this embodiment, upon illumination with a radiation source having a wavelength, for example, in the visible region, the overt feature luminesces in the visual spectrum. The person visually inspects the item for the presence or absence of the covert security feature, which may be formed in a recognizable pattern or color(s) for ease of validation. At a later time, the same or a different person can then conduct a second inspection of the item, by exposing it to a second wavelength that is distinct from the first wavelength. The presence or absence of the covert feature, detected by a machine or a human, is noted. Alternatively, the item can be inspected for the presence or absence of both the covert and overt security features at the same time, by exposing the item to one or more radiation sources that produce two different wavelengths.

### IV. EXAMPLES

The following example further illustrates the invention described herein and is in no way intended to limit the scope of the invention.

### Example 1

### Preparation of a Security Tag

A security tag is made by ball milling soda lime beads having a diameter of 100 μm for about 5 minutes to create a powder. 5 g of the crushed soda lime beads are mixed with 2 g of a borosilicate based glass having the following composition: SiO₂ 51.79 wt %; B₂O₃ 28.56 wt %; NaO 9.79 wt %; CaO 7.00 wt %; MgO 2.36 wt %; Al₂O₃ 0.29 wt %; FeO, Fe₂O₃ 0.14 wt %; K₂O 0.07 wt %. A dopant (3 mol %) is added to the crushed soda lime beads and borosilicate based glass power, and the mixture is ball milled for about 3 minutes. The resulting powder is put in a furnace and heated to at least 550° C. for about 30 minutes, or until the borosilicate based glass is melted. Then, the temperature is increased to at least 1100° C. for 1 hour to produce a homogeneous melt. The temperature is increased again to at least 1250° C. and the molten glass is poured into a brass mold at room temperature, which quenches the glass to form a transparent, bubble free borosilicate glass, doped with the dopant.

Although the invention has been described with respect to particular embodiments, it will be apparent to those skilled in the art that various changes and modifications can be made without departing from the invention.

What is claimed is:

1. A security marker, comprising:
at least one security tag comprising a first dopant incorporated into a host and a second dopant incorporated into a host, wherein said first dopant interacts with its host to luminesce in the visible spectrum upon excitation at a first wavelength, and the second dopant interacts with its host to luminesce upon excitation at a second wavelength.

2. The security marker according to claim 1, wherein at least one of the first dopant and the second dopant comprises a rare earth ion.

3. The security marker according to claim 2, wherein the rare earth ion comprises a lanthanide.

4. The security marker according to claim 3, wherein said first dopant is europium and said second dopant is terbium.

5. The security marker according to claim 1, wherein the first dopant and the second dopant are incorporated into a single host.

6. The security marker according to claim 5, wherein the single host comprises a glass or a polymer.

7. The security marker according to claim 6, wherein the glass comprises borosilicate glass.

8. The security marker according to claim 1, wherein the security marker comprises two or more security tags, one tag composed of the first dopant incorporated into a first host and a second tag composed of the second dopant incorporated into a second host.

9. The security marker according to claim 8, wherein the first host or the second host comprises a glass or a polymer.

10. The security marker according to claim 9, wherein the glass comprises borosilicate glass.

11. The security marker according to claim 1, wherein the second dopant interacts with its host to luminesce in the visible region of the electromagnetic spectrum upon excitation at the second wavelength.

12. The security marker according to claim 1, wherein the second dopant interacts with its host to luminesce outside the visible region of the electromagnetic spectrum upon excitation at the second wavelength.

13. The security marker according to claim 1, wherein the first dopant interacts with its host to luminesce upon excitation at a first wavelength that is in the visible region of the electromagnetic spectrum.

14. The security marker according to claim 13, wherein the second dopant interacts with its host to luminesce upon excitation at a second wavelength that is in the ultraviolet or infrared region of the electromagnetic spectrum.

15. The security marker according to claim 1, wherein the first dopant interacts with its host to luminesce at a first luminescent frequency, and wherein the second wavelength is different from the first luminescent frequency.

16. The security marker according to claim 1, wherein said one or more security tags are incorporated into a fluid.

17. The security marker according to claim 1, wherein said one or more security tags are applied to or incorporated into a solid.

18. The security marker of claim 1, applied to or incorporated into an object to be identified or validated, wherein the marker must be viewed at both the first and second wavelengths in order for the object to be identified or validated.

19. An anti-counterfeiting method for use in identifying or validating an object, comprising:
providing the object with a security marker comprised of at least one security tag comprising a first dopant incorporated into a host and a second dopant incorporated into a host, wherein said first dopant interacts with its host to luminesce in the visible spectrum upon excitation at a first wavelength, and the second dopant interacts with its host to luminesce upon excitation at a second wavelength,
wherein the marker must be viewed at both the first and second wavelengths to be identified or validated.

20. The method of claim 19, wherein the first dopant and the second dopant are incorporated into a single host.

21. The method according to claim 19, wherein the security marker comprises two or more security tags, one tag composed of the first dopant incorporated into a first host and a second tag composed of the second dopant incorporated into a second host.

22. The method of claim 19, wherein said providing comprises incorporating the security marker into the object.

23. The method of claim 19, wherein said providing comprises applying the security marker to the object.
